(19) United States
(12) Patent Application Publication
(10) Pub. No.: US 2023/0061374 A1
(43) Pub. Date: Mar. 2, 2023

(54) SEPARATOR FOR FUEL CELL WITH INSULATING GASKET AND FUEL CELL STACK HAVING THE SAME

(71) Applicants: Hyundai Motor Company, Seoul (KR); Kia Corporation, Seoul (KR)

(72) Inventors: Soo Jin LIM, Seongnam-si (KR); Woo Chul SHIN, Goyang-si (KR)

(73) Assignees: Hyundai Motor Company, Seoul (KR); Kia Corporation, Seoul (KR)

(21) Appl. No.: 17/738,153

(22) Filed: May 6, 2022

(30) Foreign Application Priority Data
Aug. 25, 2021 (KR) 10-2021-0112626

(51) Int. Cl. H01M 8/242; H01M 8/0247; H01M 8/0276

(52) U.S. Cl. CPC H01M 8/242; H01M 8/0247; H01M 8/0276

(57) ABSTRACT

A fuel cell stack in which plurality of cells including a plurality of reactive cells and at least one or more dummy cells is stacked, wherein each of the reactive cells has a separator for a reactive cell on which at least one or more insulating gaskets is exposedly formed on the outer surface, wherein the dummy cells have a separator for a dummy cell on which at least one or more insulating gaskets is exposedly formed on the outer surface, and wherein separators can be distinguished by means of identification gaskets exposedly formed to have different shapes, and a separator for a fuel cell for comprising the same.

### CROSS REFERENCE TO RELATED APPLICATION

The present application claims priority to Korean Patent Application No. 10-2021-0112626, filed Aug. 25, 2021, the entire contents of which is incorporated herein for all purposes by this reference.

### TECHNICAL FIELD

The present disclosure relates to a separator for a fuel cell with an insulating gasket, and a fuel cell stack having the same, and more specifically, to a separator for a fuel cell with an insulating gasket, and a fuel cell stack having the same.

### BACKGROUND

A fuel cell is a power generating apparatus in which chemical energy of fuel is electrochemically reacted in a stack and converted into electrical energy.

Generally, a membrane-electrode assembly (MEA) is located at the innermost part of a unit cell of a fuel cell, and the membrane-electrode assembly is comprised of a polymer electrolyte membrane which may transport hydrogen cations (protons), and a catalyst layer applied on both sides of the electrolyte membrane to allow for hydrogen and oxygen to react, that is, an anode and a cathode.

Further, a gas diffusion layer (GDL) is stacked on the outer portion of the membrane-electrode assembly, that is, the outer portion where the anode and cathode are located, and a separator having flow field to supply fuel and discharge water generated by the reaction is located outside the gas diffusion layer.

A plurality of unit cells configured above-mentioned is stacked in series to form a fuel cell stack for generating the desired level of output from the fuel cell. At the outermost ends of a fuel cell stack are coupled to endplates for supporting and securing in place the plurality of unit cells.

Conventionally, on the other hand, a fuel cell stack wherein a plurality of unit cells is stacked is formed, and coupled to an enclosure to protect the stack. In this method, an insulating bar that maintains clearance between the stack and the enclosure to maintain insulation from water generated within the stack and allow a stable operation of the stack may be installed.

Meanwhile, when producing a stack or coupling an enclosure to a produce stack, the external impact may cause deformation at the periphery of the separator, potentially causing to be short circuited.

Further, for effective discharge of condensate water and reduce the inflow of water generated inside the cell, a fuel cell stack including dummy cells may be configured.

On the other hand, when the fuel cell stack is configured to include such a dummy cell as above-mentioned, the metal separators for reactive cells and separators for dummy cells have identical external shapes, and there is the potential for mixing the two in the stacking process. If the separators are mixed and improperly stacked, re-fastening the stack after repair may cause the problem of degrading the stack durability.

The above description of related art is intended to help understand the background of the present disclosure, and shall not be construed to acknowledge that the present disclosure corresponds to the related art already known to those having ordinary skill in the art.

### SUMMARY

Therefore, the present disclosure has been made in view of the above problems, and it is an object of the present disclosure to provide a gasket-integrated separator used in a fuel cell, where an insulating gasket is formed on the outer surface of a separator to improve insulation between the separator and an enclosure.

In addition, another object of the present disclosure is to provide by applying a difference in shape between insulating gaskets on separators for a reactive cell and a dummy cell, thereby preventing mixing up of separators during transport and improper stacking of separators.

To accomplish the above objects, according to one aspect of the present disclosure, there is provided a separator for a fuel cell including at least one or more insulating gaskets exposedly disposed on an outer surface of the separator.

The separator may include a plurality of outer sides to face an inside of an enclosure, having at least one or more insulating gaskets disposed on each of the plurality of outer surfaces.

The at least one or more insulating gaskets may be disposed at a predetermined position to correspond to a position at which an insulating bar is disposed between the separator and the enclosure is fixed.

The at least one or more insulating gaskets may be disposed integrally with an airtight gasket which is fixedly inserted in the separator.

An identification gasket exposedly disposed on the outer side of the separator may further be included.

The separator may be a separator for a reactive cell, and the identification gasket of the separator for the reactive cell may be an identification gasket having a first shape different from a shape of the identification gasket of a separator for a dummy cell.

The identification gasket of the separator for the reactive cell may have different lengths from that of an identification gasket of the separator for the dummy cell.

The separator may be a separator for a dummy cell, and an identification gasket of the separator for the dummy cell may be an identification gasket having a second shape different from a shape of an identification gasket of a separator for a reactive cell.

The identification gasket of the separator for a dummy cell may have a length different from that of an identification gasket of the separator for the reactive cell.

The insulating gasket may have a protruding height equal to or less than a protruding height of the airtight gasket from the separator.

Further, according to a preferred embodiment of the present disclosure, a fuel cell stack including a stack including a plurality of cells including a plurality of reactive cells and at least one or more dummy cells, each of reactive cells each have at least one or more separators for a reactive cell on which an insulating gasket is exposedly disposed on an outer surface of the at least one or more separators for the reactive cell.

The at least one or more dummy cells may have at least one or more separators for a dummy cell on which an insulating gasket is exposedly disposed on an outer surface of the at least one or more separators for the dummy cell.

The insulating gasket of the at least one or more separators for the reactive cell and the insulating gasket of the at least one or more separators for the dummy cell may be disposed at a predetermined position to correspond to a position at which an insulating bar inserted inside an enclosure is fixed.

The at least one or more separators for a reactive cell may further include an identification gasket exposedly disposed on the outer surface thereof.

The at least one or more separators for a dummy cell may further include an identification gasket exposedly disposed on the outer surface of the at least one or more separators for the dummy cell.

The at least one or more separators for the reactive cell may include a first identification gasket having a first shape and exposedly disposed on the outer surface of the at least one or more separators for the reactive cell, and the at least one or more separators for the dummy cell may include a second identification gasket having a second shape different from the first shape and exposedly disposed on the outer surface of the at least one or more separators for the dummy cell.

According to a preferred embodiment of the present disclosure, providing a separator on which an integrated insulating gasket is formed has the benefits of improving insulation between a metal separator and enclosure within a limited space, and protecting the periphery of a stack from external impact.

Further, regarding the shape of an insulating gasket formed integrally on a separator for a fuel cell, by forming an insulating gasket on a reactive cell and an insulating gasket on a dummy cell with shapes that are distinguishable from each other, a benefit of preventing confusing a separator for a reactive cell for a separator for a dummy cell is provided. As improper stacking of separators in a fuel cell stack can thereby be prevented, a further benefit of improving the loss of quality and durability due to re-fastening of stacks is provided.

Further, according to a preferred embodiment of the present disclosure, as the insulating gasket functions as a stopper when a stack is fastened and prevents excessive compression of the outermost cells due to compressive load, a benefit of being able to assemble a fuel cell stack having uniform cell pitch is provided.

### BRIEF DESCRIPTION OF THE DRAWINGS

FIG. 1 is a schematic diagram showing a fuel cell stack accommodated in an enclosure;

FIG. 2 is a sectional view illustrating a cross section along the line A-A′ of FIG. 1;

FIG. 3 is a front view showing a separator for fuel cell having an insulating gasket according to a preferred embodiment of the present disclosure;

FIG. 4 is a cross sectional view showing that a separator for a fuel cell having an insulating gasket coupled to an enclosure according to a preferred embodiment of the present disclosure;

FIG. 5 is a sectional view illustrating a cross section along the line B-B′ of FIG. 3;

FIG. 6A is a view showing a separator for a reactive cell according to a first embodiment of the present disclosure, and FIG. 6B is an illustration of the separator for a dummy cell according to the first embodiment of the present disclosure;

FIG. 7 is a side view schematically showing a fuel cell stack including the separator of FIG. 6A and the separator of FIG. 6B according to the first embodiment of the present disclosure;

FIG. 8A is a view showing a separator for a reactive cell according to a second embodiment of the present disclosure, and FIG. 8B is a view showing a separator for a dummy cell according to a second embodiment of the present disclosure;

FIG. 9 is a side view schematically showing a fuel cell stack including the separator of FIG. 8A and a separator of FIG. 8B according to the second embodiment of the present disclosure;

FIG. 10A is a view showing a separator for a reactive cell according to the third embodiment of the present disclosure, and FIG. 10B is a view showing a separator for a dummy cell according to the third embodiment of the present disclosure; and

FIG. 11 is a side view schematically showing fuel cell stack including the separator of FIG. 10A and the separator of FIG. 10B according to the third embodiment of the present disclosure.

### DETAILED DESCRIPTION

Hereinafter, a separator for a fuel cell having an insulating gasket according to a preferred embodiment and a fuel cell stack including the same will be described in detail with reference to the accompanying drawings.

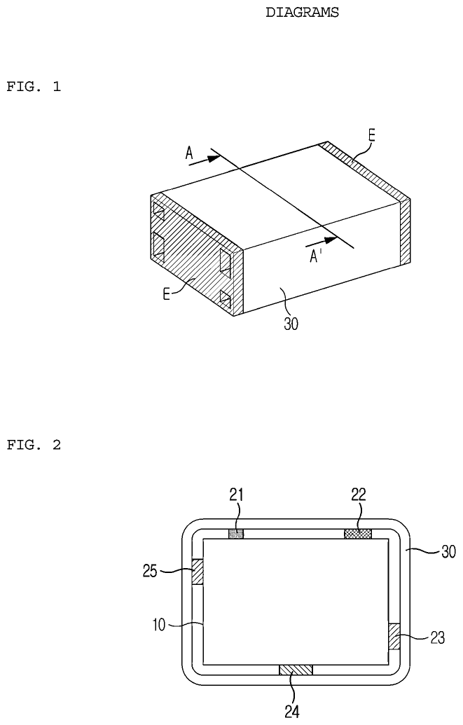

FIG. 1 is a skew drawing illustrating a fuel cell stack accommodated in an enclosure, and FIG. 2 is a sectional view illustrating a cross section along the line A-A′ of FIG. 1. Generally, to produce sufficient electrical power, a fuel cell is comprised of a fuel cell stack wherein a plurality of unit cells is stacked. These unit cells may be comprised of a membrane-electrode assembly (MEA) including a polymer electrolyte membrane, a pair of gas diffusion layers in contact with one surface and the other surface of the membrane-electrode assembly, and a pair of separators in contact with the outer surfaces of the gas diffusion layers. Whereas in the present disclosure, a polymer electrolyte membrane fuel cell wherein unit cells as described above are stacked is used for description, the present disclosure is not limited to such and the fuel cell may be any fuel cell including a separator and gasket.

A metal separator may be used as the separator included in a unit cell of the fuel cell stack, and on this separator, channels for each of hydrogen, air and cooling water may be formed for supplying each. Further, to provide airtightness against reaction gases and cooling water inside the metal separator, and to provide appropriate fastening pressure for the stacked unit cells, a gasket may be installed on the separator. Such a separator may be formed to be integrated into the separator through methods such as insert molding.

Meanwhile, an enclosure is provided to protect the fuel cell stack in which unit cells are stacked, and the fuel cell stack is accommodated in the enclosure. As illustrated in FIG. 1, an enclosure 30 accommodating a fuel cell stack within may be fastened and secured under pressure from endplates (E).

Regarding this, FIG. 2 illustrates the A-A′ cross section of FIG. 1, and as illustrated in FIG. 2, insulating bars 21, 22, 23, 24, and 25 are inserted and fixed in place between the enclosure and the fuel cell stack. These insulating bars 21, 22, 23, 24, and 25 maintain a clearance between the stack 10 and enclosure 30 to maintain insulation against water generated in the stack and allow the fuel cell stack to operate stably.

Meanwhile, a preferred embodiment of the present disclosure provides a gasket-integrated separator 100 on which an insulating gasket is additionally installed on a separator for a fuel cell, where the insulating gasket is exposedly formed on (extending from) the outer surface of the separator.

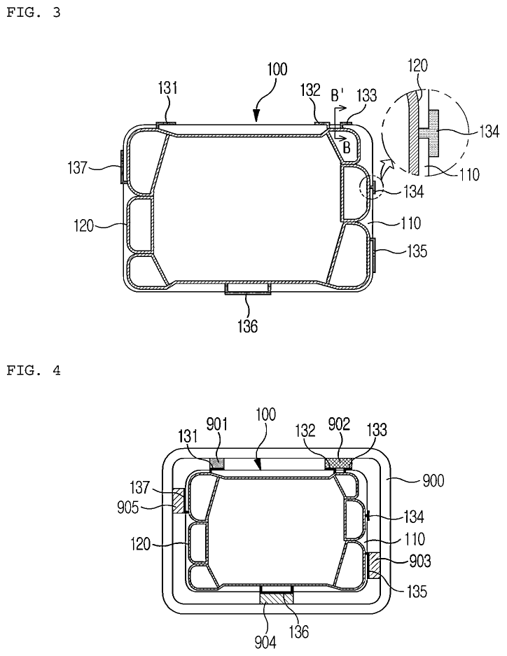

Regarding this, FIG. 3 roughly illustrates the configuration of a separator for a fuel cell having an insulating gasket according to a preferred embodiment of the present disclosure. FIG. 3 is an example of an integrated separator, roughly illustrating the inlet manifolds and outlet manifolds for hydrogen, air and cooling water on such a separator 110, and omitting the flow field formed inside the separator 110. For example, in the case of the example of FIG. 3, only the basic shapes of the separator and the gasket have been illustrated as necessary for describing the essential characteristics of the present disclosure, and parts which are unrelated to the essential characteristics of the present disclosure, for example, the shape of the periphery of the separator, shape of the inlet/outlet manifolds and other structural details are subject to change.

Referring to the example of FIG. 3, in the separator for a fuel cell according to a preferred embodiment of the present disclosure, as in the structure of ordinary schematic separator and gasket, and airtight gasket 120 may be integrally formed on the separator 110 to provide airtightness. This airtight gasket 120, as in related art, may be integrally formed on the separator 110 through insert molding, and, as shown in FIG. 3, to sufficiently shield the areas where fluid moves, may be formed to completely seal the inlet manifolds, outlet manifolds and internal flow field, etc. Meanwhile, whereas FIG. 3 shows an example wherein the separator and gasket are integrally formed, the present disclosure is not limited to such example, and may be applied to, for example, examples wherein the separator and gasket are fabricated separately and the gasket is attached to the separator.

Further, according to a preferred embodiment of the present disclosure, at least one or more insulating gasket is exposedly formed on the outer surface of the separator. Such insulating gasket may be integrally molded with an airtight gasket inserted into and fixed in place in the separator.

Regarding the shape of the outer surface of the separator, so long as a plurality of distinguishable outer surfaces which are oriented toward the inside of the enclosure, at least one or more insulating gasket 131, 132, 133, 135, 136 and 137 is preferably formed on each of the plurality of outer surfaces. Regarding this, the term ‘distinguishable outer surface’ may refer to the outer surface wherein the outer surface, excluding areas that are curved, forms a straight line.

In the example of FIG. 3, a separator having a generally rectangular shape is exemplified, with at least one or more insulating gasket 131, 132, 133, 135, 136, and 137 formed on the outer surface of each rectangle. Provided, that this is only one example, and an example wherein an insulating gasket is formed only on one specific outer surface may also be considered. Provided, that depending on the shape of the separator, sufficient insulating performance can be provided only if clearance between each outer surface and the enclosure is provided. Accordingly, according to one preferred embodiment of the present disclosure, at least one or more insulating gasket is included on all distinguishable outer surfaces.

Such an insulating gasket is for providing insulation performance, and whereas there is no particular limitation on its shape, preferably the portion exposed at the outer surface of the separator is flat. Further, as explained in the foregoing, the insulating gasket may be integrally molded with the airtight gasket, and as shown in the example of FIG. 3, the insulating gasket may be a gasket having an ‘L’ shape which is formed to extend from one end of the airtight gasket. Further, the gasket may be, as represented by symbol 134 in FIG. 3, a gasket having a ‘T’ shape, or, as represented by symbol 136, may be a ‘U’ shape gasket. In particular, whereas the individual elements are marked separately to allow for convenient distinguishing of the insulating gasket and airtight gasket, this does not mean that the insulating gasket and the airtight gasket are separate, physically isolated elements. Accordingly, the insulating gasket and airtight gasket may be simultaneously molded and integrally formed gasket.

FIG. 4 is a cross sectional drawing illustrating the separator for a fuel cell having an insulating gasket according to a preferred embodiment of the present disclosure installed inside an enclosure. FIG. 4 is an example wherein the insulating bars are installed at the same positions as in FIG. 2. According to a preferred embodiment of the present disclosure, the insulating gasket 131, 132, 133, 135, 136 and 137 of the gasket-integrated separator 100 may be formed at predetermined positions corresponding to the positions at which the insulating bars 901, 902, 903, 904 and 905 inserted between the separator and the enclosure 900. In this case, the insulating gasket may reinforce the insulating function of the insulating bars. Meanwhile, in a case where the widthwise thickness of the insulating gasket is sufficiently thick, the function of the insulating bars may be substituted.

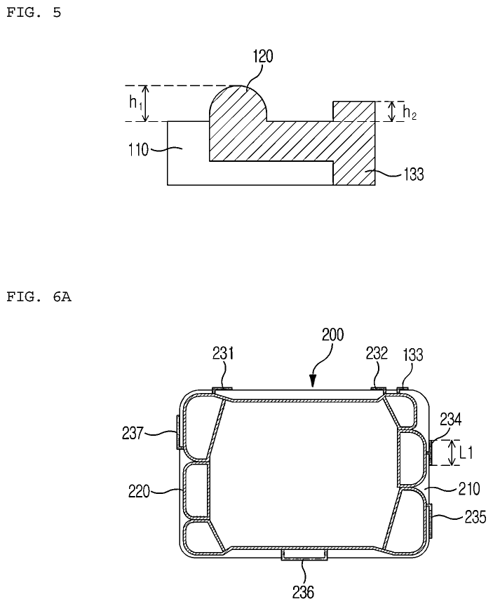

The insulating gasket is not intended to provide airtightness, and must not restrict the airtightness of the airtight gasket. Regarding this, FIG. 5 is a cross sectional drawing of the B-B′ cross section of FIG. 3, and in FIG. 5, it is illustrated that by having a difference in height between the insulating gasket 133 and airtight gasket 120, the airtight performance of the airtight gasket 120 is not restricted. To this end, the insulating gasket 133 may be formed to have a protruding height less than or equal to the height to which the airtight gasket 120 protrudes from the separator.

Specifically, with respect to the upper surface of the separator, the height h1 of the airtight gasket 120 illustrated in FIG. 5 may be higher than the height h2 of the insulating gasket 133. By having such a height difference between the two gaskets, the pressure applied to the stack may compress the airtight gasket 120 with priority, allowing for sufficient airtight performance to be ensured.

Further, in the separator according to a preferred embodiment of the present disclosure, an identification gasket 134 which is exposedly formed on the outer surface of a separator 110 may be further included. The identification gasket 134 is for distinguishing a separator for a reactive cell and a separator for a dummy cell, and is configured to allow for distinguishing of a separator for a reactive cell and a separator for a dummy cell by means of a difference in the shape of the gasket exposed outward from a separator. In the present disclosure, a separator for a reactive cell refers to a separator on which are formed inlets and outlets for reactive gases, etc. for applying to a reactive cell wherein electrical generation by reactive gases is carried out, and the separator may be, for example, a cathode separator (CP) or anode separator (AP). Meanwhile, a separator for a dummy cell refers to a separator applied to a dummy cell that is not involved in electrical power generation, and the separator may be, for example, an end cathode separator (ECP) or an end anode separator (EAP).

Further, the identification gasket may be one with an insulating functionality like an insulating gasket, and may also be one without an insulating functionality, for example, a separate element that does not contact the inner wall of the enclosure or an insulating bar inserted between the separator and enclosure. Accordingly, in one embodiment of the present disclosure, one or more of the insulating gaskets may function as an identification gasket, and in another embodiment, identification gaskets separate from the insulating gaskets may be provided. Provided, that as applying a difference in shape to an identification gasket that has insulating functionality may cause distribution of pressure at the region which contacts the enclosure, thereby causing the pressure applied to the cells to become uneven, it may be preferable not to assign an insulating functionality to an identification gasket.

In the example of FIG. 3, symbol 134 represents an identification gasket, and this identification gasket of FIG. 3 does not function as an insulating gasket (see FIG. 4).

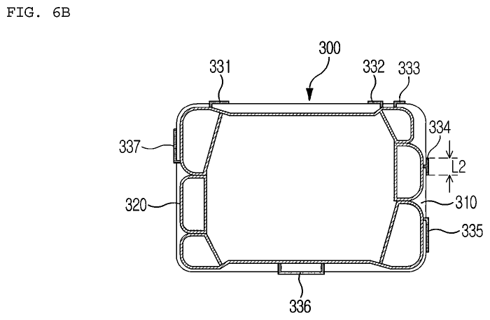

An example wherein a separator for a reactive cell can be distinguished from a separator for a dummy cell by means of an identification gasket is illustrated in FIG. 6A and FIG. 6B. FIG. 6A is an illustration of the gasket-integrated separator for a reactive cell 200 according to a first embodiment of the present disclosure, and FIG. 6B is an illustration of the gasket-integrated separator for a dummy cell 300 according to the first embodiment of the present disclosure.

In the case of FIG. 6A and FIG. 6B, examples wherein individual identification gaskets are formed on both a separator for a reactive cell 210 and a separator for a dummy cell 310. In these examples, the shape, specifically the length, of the identification gasket, is formed to be different.

First, in the case of the separator for a reactive cell 210 in FIG. 6A, the structure is identical to that of the separator of FIG. 3. For example, the insulating gaskets 231, 232, 233, 235, 236, and 237 of FIG. 6A has the same position and shape as the insulating gaskets 131, 132, 133, 135, 136 and 137 of FIG. 3, and the length L2 of the identification gasket 334 of FIG. 6B is identical to the length of the identification gasket 134 of FIG. 3. Accordingly, the length L2 of the identification gasket 334 of FIG. 6B is shorter than the length L1 of the identification gasket 234 of FIG. 6A. Preferably, this difference in length is enough to allow a worker or in-process equipment to readily distinguish a separator for a reactive cell from a reactive cell for a dummy cell according to the difference in length of the gaskets. Further, this difference in length is only one example wherein [separators] can be distinguished by means of the identification gaskets, and other differences in shape may be applied.

For example, the identification gasket of a reactive cell may be an identification gasket having a first shape, and the identification gasket of a dummy cell may be an identification gasket having a second shape different from the shape of the separator for a reactive cell.

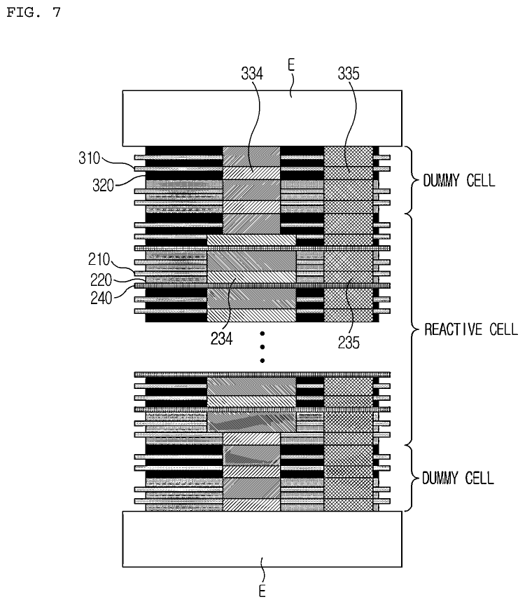

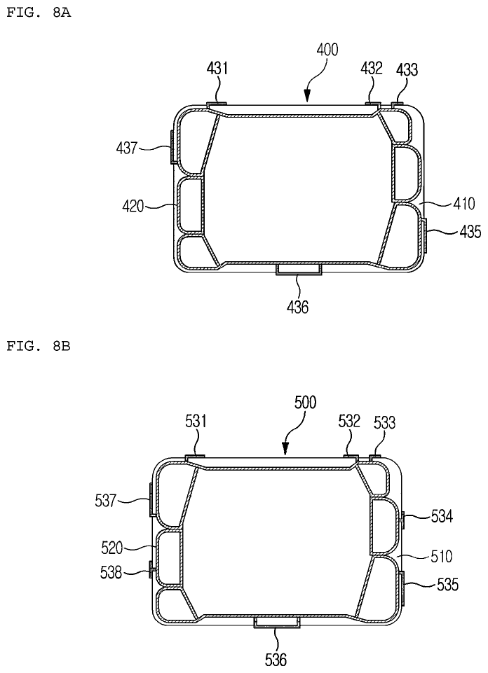

FIG. 7 is a schematic drawing of a side view of a fuel cell stack including the separator of FIG. 6A and the separator of FIG. 6B according to a first embodiment of the present disclosure. Referring to FIG. 7, mis-stacking of separators can be easily identified by means of differences in the length of the identification gaskets. That is, in a fuel cell stack which is stacked as shown in FIG. 7, a dummy cell section and a reactive cell section are clearly distinguished, and by confirming that the side surface of a stack of separators includes identification gaskets of different lengths, mis-stacking of separators can be identified simply.

Specifically, referring to FIG. 7, in the reactive cell section, separators 210 on which airtight gaskets 220 are integrally formed are stacked above and beneath an electricity-generating assembly (EGA) 240 which combines a membrane-electrode assembly and a gas diffusion layer, and on the outer surface of this separator is exposed an identification gasket 234 having a first length. On the other hand, in the case of a dummy cell section, as power generation through reactive gases does not occur in this section, an EGA is not included, and separators 310 on which identification gaskets 334 having a second length shorter than the first length may be stacked together with airtight gaskets 310. As shown in FIG. 7, the identification gasket 234 of a separator for a reactive cell has a length different from that of an identification gasket 334 for a dummy cell, allowing for immediate identification of mis-stacking with the stack in alignment, as well as removal of separators which are misclassified in the process of transport. Note that the aligned elements in the right of the drawing are insulating gaskets 235 and 335, with endplates E installed above and beneath. According to a fuel cell stack having such configuration, by having a difference in the shape of identification gaskets on the periphery of metal separators during fabrication, it is possible to identify and prevent mix-up of separators for reactive cells and separators for dummy cells, and also to do away with the need to disassemble and reassemble a stack due to mis-stacking of separators. Also, as there is almost no difference in stack volume, there is an advantage that the periphery of the stack can be protected from external impact while improving insulation between the stack and enclosure within a confined layout. Further, it is possible to prevent excessive compression of the outermost cells due to compressive load when the stack is assembled, and with the gaskets exposed outward functioning as stoppers, a further benefit of uniform cell pitch may be provided.

In the following, another embodiment of the present disclosure will be described with reference to the attached drawings. FIG. 8A is an illustration of the gasket-integrated separator 400 for a reactive cell according to a second embodiment of the present disclosure, and FIG. 8B is an illustration of the gasket-integrated separator 500 for a dummy cell according to a second embodiment of the present disclosure.

In the examples of FIG. 8A and FIG. 8B, unlike in the examples of FIGS. 6A and 6B, an example wherein an identification gasket is formed only on the separator 510 for a dummy cell, and an identification gasket is not formed on the separator 410 for a reactive cell, is illustrated.

First, in the case of the separator 410 for a reactive cell in FIG. 8A, the insulating gaskets 431, 432, 433, 435, 436, and 437 of FIG. 8A has the same position and shape as the insulating gaskets 131, 132, 133, 135, 136, and 137 of FIG. 3. Provided, that the separator 410 of FIG. 8A does not include an identification gasket.

Meanwhile, in the case of the separator 510 for a dummy cell in FIG. 8B, insulating gaskets 531, 532, 533, 535, 536, and 537 having the same position and shape as the insulating gaskets 131, 132, 133, 135, 136 and 137 of FIG. 3 are included. Further, in the separator 510 for a dummy cell in FIG. 8B, identification gaskets 534 and 538 are formed respectively on two outer sides opposite each other. Accordingly, a separator 510 for a dummy cell can be distinguished from a separator 410 for a reactive cell by the presence of identification gaskets 534 and 538.

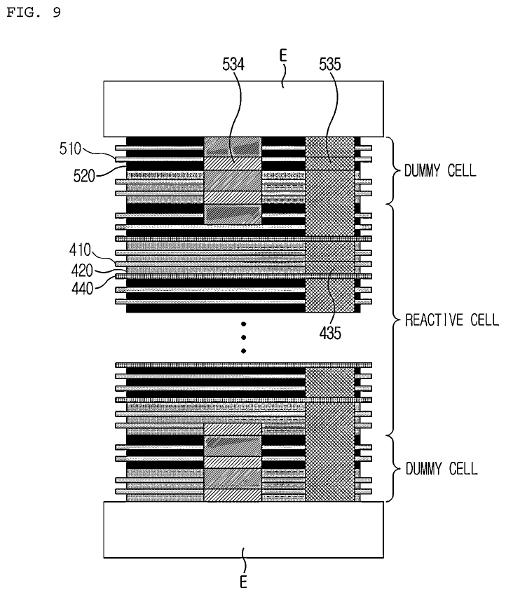

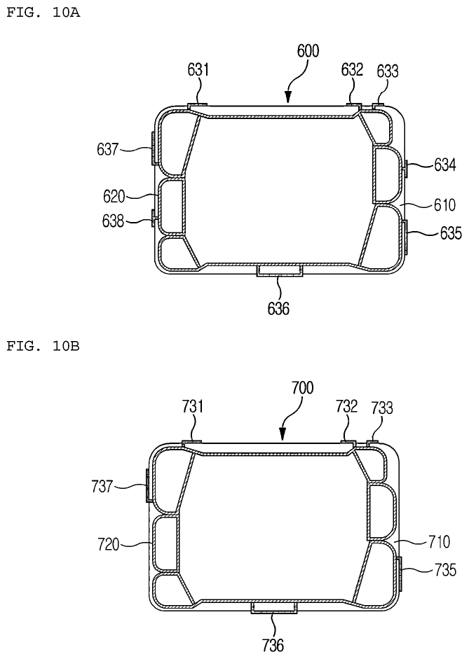

FIG. 9 is a schematic drawing of a side view of a fuel cell stack including the separator of FIG. 8A and the separator of FIG. 8B according to a second embodiment of the present disclosure.

Referring to FIG. 9, a separator 410 on which airtight gaskets 420 are integrally formed are stacked above and beneath an electricity-generating assembly (EGA) 240 which combines a membrane-electrode assembly and a gas diffusion layer, and no identification gasket is formed on the outer surfaces of these separators for a reactive cell. On the other hand, in the case of the dummy cell section, separators 510 on which an identification gasket 534 is exposed together with an airtight gasket 520 may be stacked. As shown in FIG. 9, a separator for a dummy cell can be distinguished from a separator for a reactive cell by the presence of an identification gasket 534, and accordingly, it is possible to immediately identify mis-stacking with the stack in alignment. Note that symbols ‘435’ and ‘535’ which are not explained represent insulating gaskets, and symbol ‘E’ in the drawings represents an end plate.

In a case where identification gaskets are formed only on separators for dummy cells, when a stack is assembled, relatively higher pressure is applied to the cells moving outward from the middle cells. In a case where an identification gasket is applied to a separator for a dummy cell, it can function as a stopper providing uniform cell pitch, thereby preventing excessive compression of outer cells.

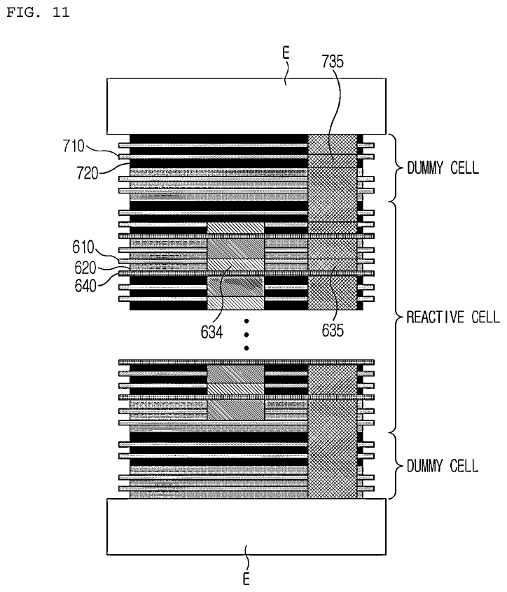

FIG. 10A is an illustration of the separator for a reactive cell according to a third embodiment of the present disclosure, and FIG. 10B is an illustration of the separator for a dummy cell according to a third embodiment of the present disclosure.

In the examples of FIG. 10A and FIG. 10B, contrary to the examples of FIGS. 8A and 8B, examples wherein an identification gasket is formed only on a separator for a reactive cell 610 and not on a separator for a dummy cell 710 are illustrated.

First, in the case of the separator 610 for a reactive cell of FIG. 10A, the insulating gaskets 631, 632, 633, 635, 636 and 637 of FIG. 10A are identical to the insulating gaskets 531, 532, 533, 535, 536 and 537 of the separator for a dummy plate of FIG. 8B. Further, in the separator 610 for a reactive cell of FIG. 10A, as with the separator 510 for a dummy cell of FIG. 8B, identification gaskets 634 and 638 are formed respectively on two outer surfaces opposite each other.

Meanwhile, the separator 710 for a dummy cell of FIG. 10B is substantially identical to the separator 410 for a reactive cell of FIG. 8A. Accordingly, the separator 710 for a dummy cell of FIG. 10B includes only insulating gaskets 731, 732, 733, 735, 736 and 737, and no separate identification gaskets are formed thereon. Accordingly, a separator 610 for a reactive cell can be distinguished from a separator 710 for a dummy cell by the presence of an identification gasket.

FIG. 11 is a schematic drawing of a side view of a fuel cell stack including the separator of FIG. 10A and the separator of FIG. 10B according to a third embodiment of the present disclosure.

Referring to FIG. 11, in a reactive cell section, separators 610 on which airtight gaskets 620 are integrally formed are stacked above and beneath an electricity-generating assembly (EGA) 640 which combines a membrane-electrode assembly and a gas diffusion layer, and an identification gasket 634 is formed on the outer surfaces of these separators for a reactive cell. On the other hand, in the case of the dummy cell section, separators 710 on which an identification gasket is not may be stacked. As shown in FIG. 9, a separator for a dummy cell can be distinguished from a separator for a reactive cell by the presence of an identification gasket 634, and accordingly, it is possible to immediately identify mis-stacking with the stack in alignment. Note that symbols ‘635’ and ‘735’ which are not explained represent insulating gaskets, and symbol ‘E’ in the drawings represents an end plate.

In a separator for a reactive cell, where the actual electrochemical reactions take place, it is important that the respective cells have uniform performance. Variance in individual cell performance may occur due to differences in cell pitch, and with the identification gaskets formed on separators for a reactive cell functioning as a stopper, the respective cells can have uniform cell pitch.

Whereas specific embodiments of the present disclosure have been illustrated and described in the above, it shall be self-evident to a person having ordinary skill in the art that the present disclosure may be improved and modified in various ways without departing from the technical idea of the present disclosure as provided by the appended claims.

What is claimed is:

1. A separator for a fuel cell comprising:
at least one or more insulating gaskets exposedly disposed on an outer surface of the separator.

2. The separator of claim 1, wherein the separator includes a plurality of outer sides to face an inside of an enclosure, and at least one or more insulating gaskets is disposed on the plurality of outer sides respectively.

3. The separator of claim 1, wherein the at least one or more insulating gaskets is disposed at a predetermined position so as to correspond to a position at which an insulating bar is disposed between enclosures.

4. The separator of claim 1,
wherein the at least one or more insulating gaskets is disposed integrally with an airtight gasket inserted into and fixed to the separator.

5. The separator of claim 1,
further including an identification gasket exposedly disposed on the outer surface of the separator.

6. The separator of claim 5,
wherein the separator is a separator for a reactive cell, and
an identification gasket of the separator for the reactive cell is an identification gasket having a first shape different from a shape of an identification gasket of a separator for a dummy cell.

7. The separator of claim 6,
wherein the identification gasket of the separator for the reactive cell has different lengths from that of the identification gasket of the separator for the dummy cell.

8. The separator of claim 5,
wherein the separator is a separator for a dummy cell, and an identification gasket of the separator for the dummy cell is an identification gasket having a second shape different from a shape of an identification gasket of a separator for a reactive cell.

9. The separator of claim 8,
wherein the identification gasket of the separator for the dummy cell has a length different from that of the identification gasket of the separator for the reactive cell.

10. The separator of claim 4,
wherein the insulating gasket has a protruded height less than or equal to a height by which the airtight gasket protrudes from the separator.

11. A fuel cell stack comprising a stack comprising a plurality of cells including a plurality of reactive cells and at least one or more dummy cells,
wherein the respective reactive cells each have at least one or more separators for a reactive cell on which an insulating gasket is exposedly disposed on an outer side of the at least one or more separators for the reactive cell.

12. The fuel cell stack of claim 11,
wherein the at least one or more dummy cells has at least one or more separators for a dummy cell on which an insulating gasket is exposedly disposed on an outer surface of the at least one or more separators for the dummy cell.

13. The fuel cell stack of claim 12,
wherein the insulating gasket of the at least one or more separators for the reactive cell and the insulating gasket of the at least one or more separators for the dummy cell are disposed at a predetermined position to correspond to a position at which an insulating bar inserted inside an enclosure is fixed.

14. The fuel cell stack of claim 12,
wherein the insulating gasket of the at least one or more separators for the reactive cell and the insulating gasket of the at least one or more separators for the dummy cell are integrally disposed with an airtight gasket inserted into and fixed in place in their respective separators.

15. The fuel cell stack of claim 12,
wherein the at least one or more separators for the reactive cell further includes an identification gasket exposedly disposed on the outer surface thereof.

16. The fuel cell stack of claim 12,
wherein the at least one or more separators for the dummy cell further includes an identification gasket exposedly disposed on the outer surface thereof.

17. The fuel cell stack of claim 12,
wherein the at least one or more separators for the reactive cell includes a first identification gasket having a first shape and exposedly disposed on the outer surface of the at least one or more separators for the reactive cell, and the at least one or more separators for the dummy cell includes a second identification gasket having a second shape different from the first shape and exposedly disposed on the outer surface of the at least one or more separators for the dummy cell.
